(19) United States
(12) Patent Application Publication
(10) Pub. No.: US 2011/0230805 A1
(43) Pub. Date: Sep. 22, 2011

(54) CARPAL ACTIVE PROTECTION SYSTEMS (CAPS)

(76) Inventor: Amir Oron, Tel Aviv (IL)

(21) Appl. No.: 13/120,576

(22) PCT Filed: Sep. 23, 2009
(86) PCT No.: PCT/IL09/00917

§ 371 Date: Jun. 14, 2011

Related U.S. Application Data
(60) Provisional application No. 61/099,267, filed on Sep. 23, 2008.

(51) Int. Cl. A61H 15/00

(52) U.S. Cl. 601/118

(57) ABSTRACT

A specially designed support is disclosed aimed at supporting the proximal and/or distal forearm and wrist areas while actively transferring a limited and directed pressure to the volar aspect of the distal forearm and wrist. The action is not coupled to movement performed by the user. This force, in turn, allows for enhancing venous return from the area, and thus acts to prevent ailments caused by use of computer input devices (e.g. computer mouse, keyboard). The support further comprises a motor exerting said repetitive pressure or possibly other means for forming such movement as described. The support utilizes continuous movement to alter and better the physiology of computer users, lessening chances of occurrence of pathology specifically known as carpal tunnel syndrome and possibly alleviating this condition altogether The support may be used in a mouse pad, keyboard rest or arm rest. This design may be augmented by other modifications and additions which may be utilized in conjunction with the current invention or as inventions or modifications in their own right.

### REFERENCES CITED

### U.S. Patent Documents

U.S. Pat. No. 5,490,647 issued Feb. 13, 1996 to Gregory H. Rice

U.S. Pat. No. 5,566,913 issued Oct. 22, 1996 to David M. Prokop

U.S. Pat. No. 5,375,800 issued Dec. 27, 1994 to Katherine C. Wilcox et. al.

U.S. Pat. No. 5,120,117 issued Jun. 9, 1992, to Chauncey L. Williams

U.S. Pat. No. 5,628,483 issued May 13, 1997 to Mark R. Smith and Philip G. Wessells

U.S. Pat. Application No. 2002/0113175 A1 filed Feb. 12, 2002 by Carmen Dillon

U.S. Pat. No. 6,599,259 B2 issued Jul. 29, 2003 to Brett J. Muir

U.S. Pat. No. 6,323,841 B1 issued on Nov. 27, 2001 to Sun-Long Lai

U.S. Pat. Application No. 2004/0189606 A1 published Sep. 30, 2004 by Eakkapong Powpong

U.S. Pat. No. 6,679,857 B1 issued Jan. 20, 2004 to Bastia et. al.

U.S. Pat. Application Publication No. 2004/0089771 A1 published May 13, 2004 by Zsolt Pap

U.S. Pat. No. 5,674,423 issued Oct. 7, 1997 to Dennis E. Wright Sr.

U.S. Pat. No. 5,596,481 issued Jan. 21, 1997 to Peter M. Liu, Robert L. McMahan

U.S. Pat. No. 6,237,879 issued May 29, 2001 to Michael Budge.

### Reference to Literature in the Field:

1. Burgess R A, Thompson R t, Roffman G B. The effect of forearm posture on wrist flexion in computer workers with chronic upper extremity musculoskeletal disorders. BMC Musculoskelet Disord. 2008 Apr. 11; 9:47

2. Atroshi I, Gummesson C, Ornstein E et al. Carpal tunnel syndrome and keyboard use at work: a population-based study. Arthritis Rheum. 2007 November; 56(11):3620-5.

3. Rempel D M, Keir P J, Bach J M. Effect of wrist posture on carpal tunnel pressure while typing. J Orthop Res. 2008 September; 26(9):1269-73.

4. Keir P J, Bach J M, Hudes M, Rempel D M. Guidelines for wrist posture based on carpal tunnel pressure thresholds. Hum Factors. 2007 February; 49(1):88-99.

5. Lincoln A E, Vernick J S, Ogaitis S et al. Interventions for the primary prevention of work-related carpal tunnel syndrome. Am J Prey Med. 2000 May; 18(4 Suppl):37-50. Review.

6. Verhagen A P, Bierma-Zeinstra S M, Feleus A et al. Ergonomic and physiotherapeutic interventions for treating upper extremity work related disorders in adults. Cochrane Database Syst Rev. 2004;(1):CD003471. Review.

7. Verhagen A P, Karels C, Bierma-Zeinstra S M et al. Ergonomic and physiotherapeutic interventions for treating work-related complaints of the arm, neck or shoulder in adults. A Cochrane systematic review. Eura Medicophys. 2007 September; 43(3):391-405. Review.

8. van den Heuvel S G, Ijmker S, Blatter B M et al. Loss of productivity due to neck/shoulder symptoms and hand/arm symptoms: results from the PROMO-study. J Occup Rehabil. 2007 September; 17(3):370-82.

### BACKGROUND OF THE INVENTION

1. Field of the Invention

This invention relates to supports for computer input devices and more particularly to a devised active protection system to the carpal area at the wrist—which actively uses a motor or other energy source to impart pressure on the volar aspect of the distal forearm not coupled with users' motion for decreasing the risk of repetitive stress injuries to computer users such as carpal tunnel syndrome, tenosynovitis and others. The invention is related to a category deemed ergonomic devices for computer users and holds physiologic benefits as well.

2. Description of Related and Prior Art

With the abundance of use of computers, and their ever growing part in our lives, people are inclined to use them ever so often. Many spend hours on end using computers either as part of their daily work routine or during their leisure time. With the ever expanding number of users as well as growing hours of use of computers the human interface is based on use of two main input devices i.e. the computer mouse and keyboard. Users spending time interfacing with computers are increasingly susceptible to cumulative repetitive stress injuries; among these one can find Carpal Tunnel Syndrome, the Occupational overuse syndrome, tenosynovitis, cumulative trauma disorder and others. Much attention is paid to the correct use of computer interface devices, and ergonomic principles are adhered to with growing awe. An avid work station applies these principles and emphasizes correct use of the input devices so as to prevent as much as possible the occurrence of these computer related injuries.

Attempts at preventing such injuries have brought about the use of keyboard pads which are essentially pads of encased gel-like materials upon which computer users' hands may rest. Others have used mouse pads of different designs incorporating a range of additions in order to further prevent these injuries. Ergonomic principles have led to the design and manufacture of prefabricated work stations abiding to these principles as well as additions to tables and chairs such as arm rests, foldable keyboard drawers, screen positioning arms and other accessories. Many attempts have been made to prevent computer related injuries employing different methods, incorporating an array of accessories and said technological breakthroughs, some with relative success and others not withstanding the test of time. Computer related injuries are becoming more abundant in spite of all these efforts and their economic perils instigated in loss of productivity, medical expenses etc., are substantial.

The present invention relates to the concept that imparting pressure on the volar aspect of the distal forearm of a computer user, at determined magnitude and direction and not coupled with users' motions—will increase venous outflow from the region and thus act to actively prevent computer use related injuries and most of all carpal tunnel syndrome. To that effect a preferred embodiment might be a mouse pad incorporating a motorized unit imparting a pressure directed from distal to proximal at a predetermined magnitude, repetition cycles and area.

The present invention utilizes either in conjunction or on its own, another concept utilizing a difference in the relative freedom of movement between the distal forearm rest and a proximal forearm or elbow rest. By utilizing this freedom of movement difference, a “tensioning” movement is attained acting on the transverse ligament at the volar aspect of the wrist. In turn, this repetitive tensioning movement may bring about an enhancement in ligament elasticity. Enhanced ligament elasticity may have a lasting effect in preventing confinement of the carpal space, and have other physiologic effects to that matter as may be appreciated by those familiar with the art.

The present invention utilizes either in conjunction or on its own, yet another concept utilizing a “bubble” situated at the base of said device more relevant to the device when utilized as a “keyboard rest” and allowing for an array of dynamically changing angles to be utilized by the computer user. Working within this constantly changing array of angles allows pressure around the wrist area to be directed at different tissues during a single work session and thus may act to prevent repetitive strain and other ailments known to those familiar with the art.

The present invention utilizes either in conjunction or on its own, yet another concept utilizing a cover pattern in a form directing the wrist and forearm to their preferred placing thus shortening the parking time (“parking time” is a concept known to those familiar with the art in that a hand will be repositioned at this time interval). This pattern will be governed by a series of lines and spaces forming essentially a “target” pattern. This pattern will not necessarily be of a circular shape but may very well incorporate the anatomical curvatures of the forearm or wrist areas, thus aiding in their correct and swift placement.

Prior Art:

Mouse pads, wrist rests and other support surfaces with different attributes have been described in the prior art. Examples of the prior art are the following U.S. Pat. No. 5,490,647 issued Feb. 13, 1996 to Gregory H. Rice, U.S. Pat. No. 5,566,913 issued Oct. 22, 1996 to David M. Prokop, U.S. Pat. No. 5,375,800 issued Dec. 27, 1994 to Katherine C. Wilcox et. al., U.S. Pat. No. 5,120,117 issued Jun. 9, 1992, to Chauncey L. Williams, U.S. Pat. No. 5,628,483 issued May 13, 1997 to Mark R. Smith and Philip G. Wessells all the above are examples of prior art regarding computer accessories and their like.

U.S. Pat. Application No. 2002/0113175 A1 filed Feb. 12, 2002 by Carmen Dillon discloses a wrist support which forms a cradle by supporting the thumb and fifth digit in order to ease strain on the wrist. However, the wrist support disclosed in this application does not deliver any form of pressure to the distal forearm.

U.S. Pat. No. 6,599,259 B2 issued Jul. 29, 2003 to Brett J. Muir and U.S. Pat. No. 6,323,841 B1 issued on Nov. 27, 2001 to Sun-Long Lai and U.S. Pat. Application No. 2004/0189606 A1 published Sep. 30, 2004 by Eakkapong Powpong all disclose input devices—a computer mouse—with a massage function acting at the palm of the hand with no reference to a mouse pad or keyboard support.

U.S. Pat. No. 6,679,857 B1 issued Jan. 20, 2004 to Bastia et. al., discloses massagers having gel coverings (consult Sandy), the invention disclosed deals with massagers vibrating under a gel cover incorporated in several embodiments including a hand held massager, foot massager, mouse and keyboard pads. However, the disclosed in this patent relates to a vibrating massage with no determined direction and covering only the wrist area as does a conventional mouse or keyboard pad.

U.S. Pat. Application Publication No. 2004/0089771 A1 published May 13, 2004 by Zsolt Pap discloses an ergonomic support surface supporting a computer user's wrist and delivering a massage motion. However this happens only when the user's hand moves and without incorporating a motor in it, thus it delivers a massage coupled with user movement.

U.S. Pat. No. 5,674,423 issued Oct. 7, 1997 to Dennis E. Wright, Sr. discloses a computer mouse pad which is heated to provide potential therapeutic treatment using this modality. However, no directed pressure is disclosed as part of the invention.

However, none of the above inventions and patents, taken either singly or in combination, is seen to describe the instant invention as claimed.

### SUMMARY OF THE INVENTION

A specially designed support is disclosed aimed at supporting the proximal and/or distal forearm and wrist areas while actively transferring a limited and directed pressure to the volar aspect of the distal forearm and wrist. The action is not coupled to movement performed by the user. The ergonomically designed support comes into contact with both wrist area and distal forearm and may also have a designed support supporting the proximal forearm and elbow region while distance between the two supports may be adjusted. The support exerts a predetermined pressure wave which causes an enhancement in venous outflow which in turn causes enhanced arterial blood inflow to the carpal area which is to effect a circulation modifying action in the wrist and distal forearm area. The pressure directed at the volar aspect of the distal forearm acts in a direction from distal to proximal at a determined magnitude and cycle repetition rate thus enhancing venous sufficiency. This force, by enhancing venous return from the area, acts to prevent ailments caused by use of computer input devices (e.g. computer mouse) in general and specifically carpal tunnel syndrome. The support further comprises a motor exerting said repetitive pressure or possibly other means for forming such movement as hereby described. The support utilizes continuous movement to alter and better the physiology of computer users, lessening chances of occurrence of pathology specifically known as carpal tunnel syndrome and possibly alleviating this condition altogether. The support may further be incorporated as a support built at a width similar to a keyboard or as two prefabricated supports for each of the hands.

Accordingly, it is a principle object of the invention to provide a support to a computer users' forearm which will be placed on the work surface (presumably a desk) and exert a force directed in a distal to proximal direction, at determined magnitude, location and cycle rate to cause enhancement of venous return and thus circulation within the vicinity of the Carpal Tunnel.

It is a further object of the invention to be built to accommodate hands of different size and may have adjustable components to do so.

It is further another object of the invention that said support may tend to exert said predetermined force to an area presumably containing major venous structures and may as well exert this pressure wave to a length beyond venous valves situated within the veins of the forearm, thus preventing return of venous blood past these valves.

It is further another object of the invention that both parts of said support (at distal and proximal aspects of the forearm), in their entirety, may be situated on cushions which may be inflated to allow for movement of one or the other or both parts simultaneously. This will allow for controlled movement of mainly the distal part of the support and possibly a limited motion of the proximal part of the support. Thus, a difference in relative freedom of movement between the two supports exerts a tensioning movement on the transverse ligament overlying the carpal tunnel.

It is further another object of the invention that the proximal support may be stationed on a set of railings or other means which may be adjustable to allow for a change in work angle and may allow support to the proximal forearm when the actual support of the proximal part is not situated on the computer users' desk but i.e. is situated in mid air. It is pointed out that this mid air position may make use of a “spring” mechanism thus allowing a “bouncing” effect to said rest.

It is further another object of the invention to utilize a “target” like pattern i.e. incorporating a graphic design “aiming” or “pointing” the user to placing the hand in the desired spot in as short an interval and as correct as possible—thus shortening “parking” times.

It is further another object of the invention to allow incorporation of possible embodiments of it to be incorporated or used in conjunction with a laptop or portable computer—allowing for incorporation of the above objects as well as extending the wrist resting area which is another object of the invention.

It is further another object of the invention to allow for a directional flow within the venous system of the hand from distal to proximal. Thus, an enhanced arterial flow may be caused. This object may be met by compression of the volar aspect of the wrist, or any aspects of the wrist in combination.

### BRIEF DESCRIPTION OF THE DRAWINGS

FIG. 1 is a perspective view of a support structured to contain the wrist and distal forearm and deliver a force of determined magnitude from distal to proximal in one preferred embodiment.

FIG. 2 is a perspective view of the embodiment depicted in FIG. 1 with some internal details and structure shown. These features are now shown in mechanical detail in this view.

FIG. 3 is a perspective view of the embodiment depicted in FIG. 1 showing said preferred embodiment as a completed motorized unit—with direction of action shown.

FIG. 4A is yet another perspective view of preferred embodiment depicted in FIG. 1 with the distal forearm and wrist situated above it, and with use of a computer mouse.

FIG. 4B depicts a possible layout of venous structures at the volar aspect of the human forearm and wrist areas—which may very well be affected by the action of the invention as presented in either of the embodiments shown here.

FIG. 5 is a perspective view of a possible incorporation of the embodiment depicted in FIG. 1 or those depicted in FIGS. 7-9 utilizing a rest for the distal forearm and wrist and proximal forearm interconnected at a view from above and over the computer user.

FIG. 6A is a perspective view of the embodiment depicted in FIG. 5 showing said preferred embodiment with forearm situated above it, from a lateral view note arrows depicting different freedom of movement between the two interconnected cushions.

FIG. 6B is a perspective view of the embodiment depicted in FIG. 5 showing said preferred embodiment with forearm situated above it, from above (AP view) note arrows depicting different freedom of movement between the two interconnected cushions.

FIG. 7 is a perspective view of a support structured to contain the wrist and distal forearm and deliver a force of determined magnitude from distal to proximal in another preferred embodiment different from that depicted in FIG. 1 and which may be incorporated in conjunction with the concept presented in FIGS. 5-6B.

FIG. 8 is a perspective view of a support structured to contain the wrist and distal forearm and deliver a force of determined magnitude from distal to proximal in another preferred embodiment different from that depicted in FIG. 1 and which may be incorporated in conjunction with the concept presented in FIGS. 5-6B.

FIG. 9 is a perspective view of a support structured to contain the wrist and distal forearm and deliver a force of determined magnitude from distal to proximal in another preferred embodiment different from that depicted in FIG. 1 and which may be incorporated in conjunction with the concept presented in FIGS. 5-6B.

FIG. 10A is a perspective view of a support structured to allow support of the wrist and distal forearm and deliver a force of determined magnitude from distal to proximal when using a keyboard. The force may be generated by an embodiment similar to that shown in FIG. 10B or utilize the concepts presented in FIGS. 1, 7-9.

FIG. 10B is a sectional view of the embodiment depicted in FIG. 10A at the point shown in FIG. 10A, with some features hidden within said embodiment now featured within sectional view. Note that the force acting from distal to proximal may be generated by an embodiment similar to that shown in FIG. 10B or utilize the concepts presented in FIGS. 1, 7-9.

FIG. 11A is a perspective view of a support structured to allow for its attachment or placing adjacent to a portable computer. This figure depicts said support when not attached to portable computer, whilst said support may utilize concepts depicted in any of the above FIGs.

FIG. 11B is a perspective view of a support structured to allow for its attachment or placing adjacent to a portable computer. This figure depicts said support when attached to portable computer, whilst said support may utilize concepts depicted in any of the above FIGs.

FIG. 12 is a perspective view of a support structured to allow for its attachment or placing adjacent to a portable computer. This figure depicts said support when attached to portable computer, and used by user, whilst said support may utilize concepts depicted in any of the above FIGs. Said support may span the entire portable computer edge or further.

FIG. 13A is a perspective view of a support structured to allow for its attachment or placing adjacent to a portable computer. This figure depicts said support when attached to portable computer, whilst said support may utilize concepts depicted in any of the above FIGs. The support is powered utilizing the USB outlet or other power source tangible for supplying the support with power.

FIG. 13B is a perspective view of a support structured to allow for its attachment or placing adjacent to a portable computer. This figure depicts said support when attached to portable computer, whilst said support may utilize concepts depicted in any of the above FIGs. The support is powered utilizing a battery pack for supplying the support with power.

FIG. 13C is a perspective view of a support structured to allow for its attachment or placing adjacent to a portable computer. This figure depicts said support when attached to portable computer, whilst said support may utilize concepts depicted in any of the above FIGs. The support is powered utilizing a spring mechanism which may be manually “charged” or “cocked up” for supplying the support with power.

### DETAILED DESCRIPTION OF THE INVENTION

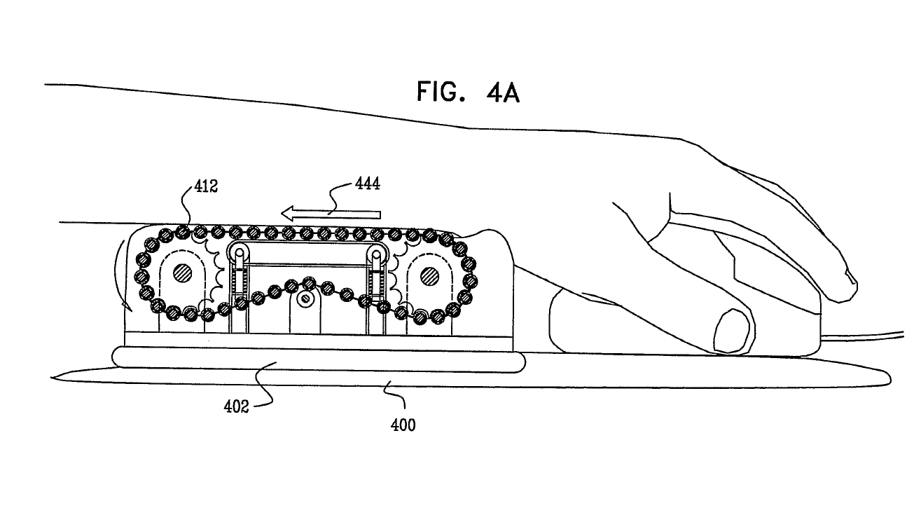

FIG. 4B depicts the superficial venous system of the distal forearm and wrist which is tied to and on which the present invention relies upon and relates to. It should be stated that processes causing pressure within the carpal tunnel may alter blood supply to the median nerve causing carpal tunnel syndrome and/or neurotrophic changes over time. It should be stated that tenosynovitis as a pathological process may bring about enhancement of structures within the carpal tunnel thus impinging on blood supply and/or may be a pathological process in its own right, causing pain and discomfort. Since FIG. 4B depicts the venous blood supply of the distal forearm. The current invention utilizes the placement of force relaying modules within the vicinity of these venous structures to enhance blood flow along them in a distal to proximal direction. It is further stated that force acting within the vicinity of these structures may cause their collapse thus rendering them almost free of blood from within and causing a “pressure wave” which will in turn allow for an ease of later filling and eventual enhancement of blood supply to the area at hand. Arteries generally supply the tissues of the body with fresh oxygen and nutrient rich blood. This blood is pushed through the arteries to capillaries and then to the veins of the forearm. By collapsing the veins ahead of time the blood passing to the forearm will “see” conditions of lessened pressure at the corresponding veins and thus more blood will be supplied to the relevant tissues, with a greater ease, due to the fact that this supplied blood will not have to “push” new blood from the veins on. It is an object of the current invention to mainly compress the venous system and to a lesser extent the arterial system. The lymphatic system of the distal forearm and hand may be compressed by the action of the current invention, adding to liquid influx into the forearm from the wrist and hand further adding to the effects of enhanced ridding of the treated areas vicinity of waste products and moreover, enhancing lymphatic tissue action and flow to act as another modifying process in computer associated pathological conditions.

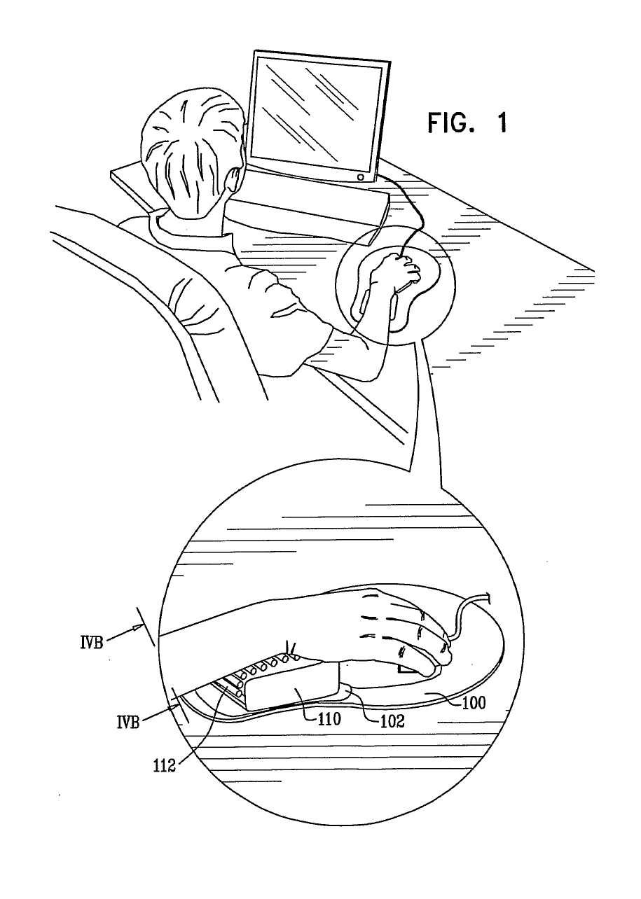

One embodiment of a support device for use by a computer user that provides uncoupled force acting from distal to proximal at a predetermined magnitude, rate and length so as to allow for enhancement of venous outflow from the hand, wrist and distal forearm is depicted in FIG. 1. This figure (FIG. 1) depicts a support device for use by a computer user that provides an uncoupled force acting from distal to proximal at a predetermined magnitude, rate and length so as to allow for enhancement of venous outflow from the hand, wrist and distal forearm. The device depicted imparts a “pressure wave” along the wrist and distal forearm which enhances venous outflow from the tissues of the hand, wrist and distal forearm. The device depicted in this embodiment is composed of a base (100) on which is situated a “floating” chamber which is filed with gas or liquid or the like and allows a controlled sliding motion (102) while on top of it is situated a motor unit (110) with rolling pins that act to move a belt of cylinders (112) spaced and formed in a predetermined fashion, which then conveys pressure in a predetermined pattern and energy so as to compress the veins of the wrist and forearm in a distal to proximal direction. It should be noted more than two pins may be incorporated. The direction of compression, its' imparting along a determined length which is to be more than the breadth of at least one valve situated within a vein of the forearm, and the degree of compression over the volar aspect of the wrist and forearm are all aimed at optimizing venous evacuation from the wrist and distal forearm. The current embodiment has a number of supporting members (not shown), situated at key anatomical locations which may be positioned so as to accommodate different wrist sizes, allowing optimal positioning of said supporting surfaces. This positioning may be determined by a lever (not shown). These supporting members may be of a soft material allowing for support to be transferred through an anatomical area dispersing pressure to a wide key area and avoiding high compressive impaction in these key anatomical locations. The embodiment depicted in FIG. 1 will be situated on a cushion (102) which may be inflated and allow for controlling pressure passed to the tissues of the wrist and distal forearm. This cushion may also allow for slight sliding of the entire support over the base. This cushion may have an element (not shown) allowing for deflation and inflation. This cushion may further have a restrictor or restrictors (not shown) at its base possibly prohibiting movement beyond a certain extent and stabilizing the surface. The device as depicted in FIG. 1 may receive the energy needed for the motor unit (110) it contains from a battery pack incorporated in it (not shown) or from a cable (not shown) connected to either the computer or a power outlet. Furthermore, the cable (not shown), when connected to the computer may relay information to a processing unit (not shown) as to use of the computer mouse, keyboard, its intensity and length of time and other aspects relevant which may all be relayed via a designated computer program. In turn, the processing unit (not shown) may relay information to the motor to either stop working or, when called for, alter work cycles to enhance circulation within the distal forearm and wrist. The effects of the processing unit may be performed by a computer program which in turn will control the utilization of the motor and its effects on circulation in the distal forearm and wrist. Alternatively or in conjunction there will be a sensor of either a mechanical pressure or other type (magnetic force, light emission, heat etc.) that will cause the motor to turn on and impart the designated movement (not shown). The device will have an on/off switch (not shown) which will allow the user to turn off the motor completely.

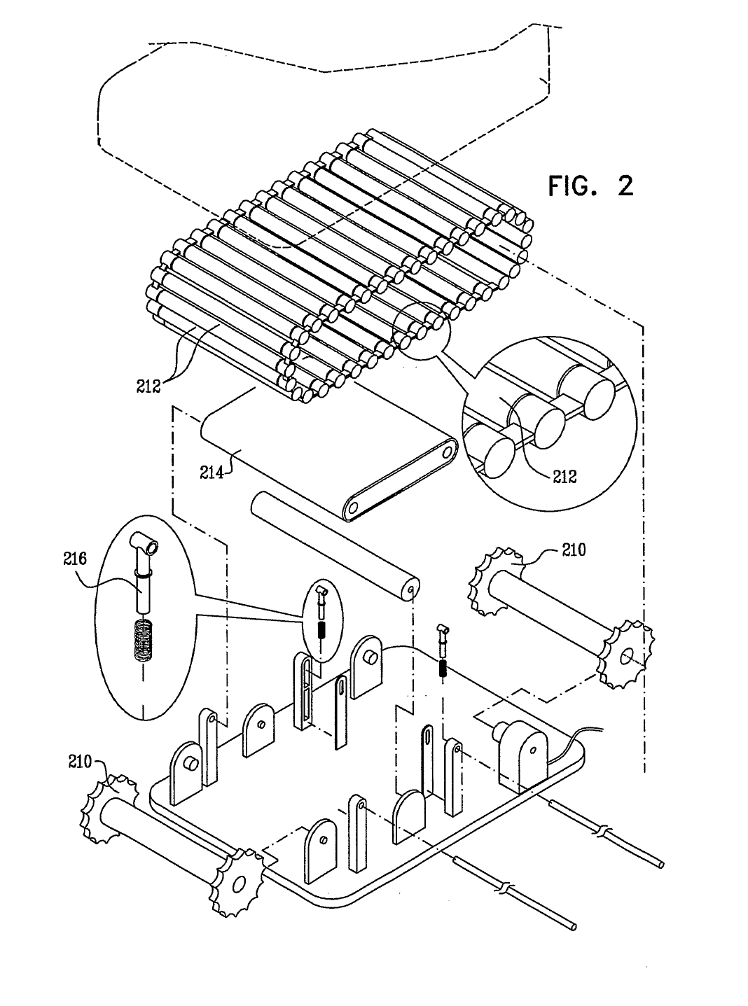

FIG. 2 depicts the embodiment of FIG. 1—specifically of the motor unit in detail. Shown in detail are the rotating pins (210) which move the chain of cylinders (212) which may rotate upon themselves when rolling. The chain is situated on a conveyer belt (214) which in turn is mounded on a number of shock absorbers (216) allowing for moderating the effects of pressure imposed on the constructs of the device by the distal forearm and wrist.

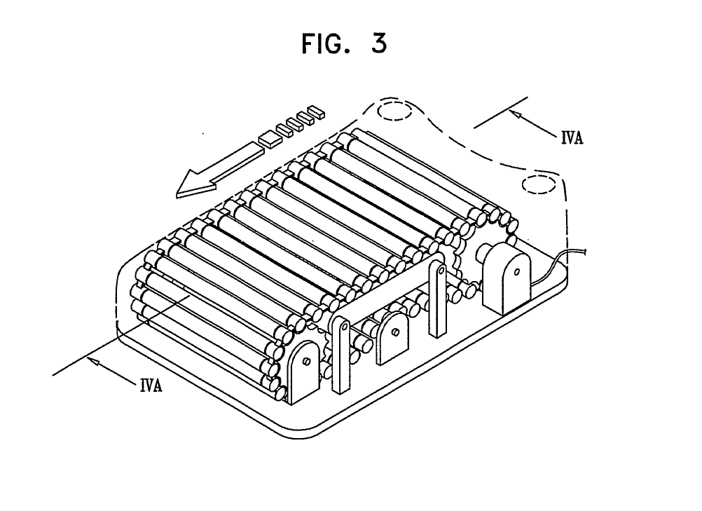

FIG. 3 shows part of the embodiment depicted in FIGS. 1 and 2 and here specifically the motor unit as a whole with the parts depicted in FIG. 2 combined. Note that the arrow at left hand side of the unit depicts the direction of action. An action that is derived from the moving cylinder chain—in this embodiment, which is continually moving and supplying pressure at determined increments, rate, and force to the volar aspect of the distal forearm and wrist in a distal to proximal direction. This motion is not coupled with user's movement. The outer casing of the motor unit is depicted by the dotted line. As part of the support, not shown here, a number of semi-solid ridges supporting the local carpal anatomy including the scaphoid tuberosity, triquetral volar ridge, the hook of hamate and thenar musculature may be incorporated.

FIG. 4A depicts the embodiment shown in FIGS. 1,2 and 3 in part. Here, one may appreciate the placement of the distal forearm and wrist areas on the support. The arrow (444) depicts the direction of movement of the rolling cylinder chain (412), which turns again and again. Note that the base (400) and cushion (402) are situated on a surface. The base may act as a surface placemat for use of the computer mouse or may be confined to the limits of the device/support.

FIG. 4B was discussed earlier in this text and depicts a possible anatomical layout of the volar venous system in a human distal forearm, wrist and hand with implications thereof on the action and utilization of this invention.

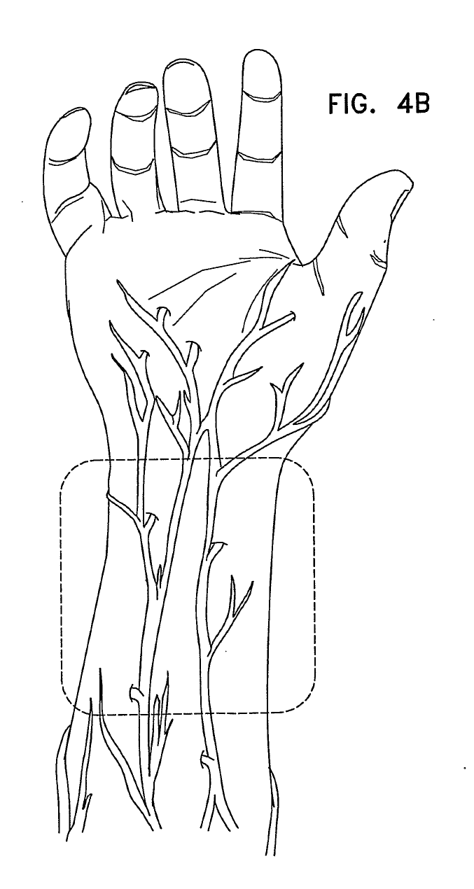

FIG. 5 shows another aspect of the current invention which may be incorporated in all the embodiments described here (FIGS. 1-4, FIGS. 7-9) and possibly in combination with other embodiments not shown here or utilized in its entirety on its own. The depiction here is of a proximal base (508) with a designated support and slide cushion (518) placed above it for placement of proximal forearm or elbow. It should be noted that this cushion may be divided into two cushions (not shown) combining one, the controlled sliding motion and the other utilized for support and comfort, alternatively, the sliding motion may be gained by use of two surfaces, a cylinder mechanism or the like (not shown). The sliding and support cushion may be filled by gas or liquid, and thus may be inflated to accommodate said computer users' needs. The distal base, which may be equipped with a motor unit (510) may be situated on a cushion (502) which in turn is situated on a base (500). The cushion (502) is intended to act as a sliding module and/or as a shock absorbing mechanism. The cushion (502) may be divided into two cushions (not shown) combining one, the controlled sliding motion and the other utilized for support and comfort, alternatively, the sliding motion may be gained by use of two surfaces, a cylinder mechanism or the like (not shown). The sliding and support cushion may be filled by gas or liquid, and thus may be inflated to accommodate said computer users' needs. It is an object of the current invention to incorporate a higher degree of sliding and “freedom” at the distal base and less sliding or “freedom” of movement in the proximal base, a point elaborated on in the later text. Noted is the fact that between the proximal and distal base are situated two slants (538) which interconnect. These slants may be placed at variable angles and allow fixing the proximal base at variable distances from the distal wrist and forearm support. The proximal and distal supports may allow for a “floating” motion due to the fact they are both elevated by cushions. This motion in turn may allow for some tension to be formed between the proximal forearm and the more distal forearm and wrist, a tension which may act upon the carpal tunnel, and specifically stretch and release the transverse carpal ligament adding to its elasticity over time.

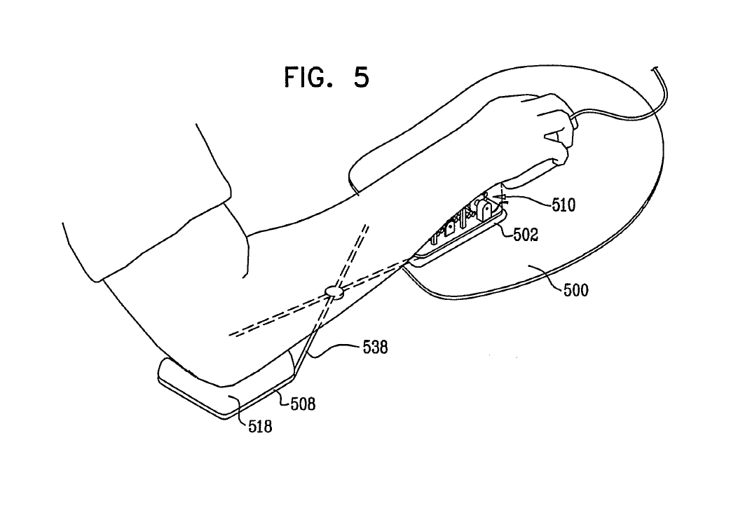

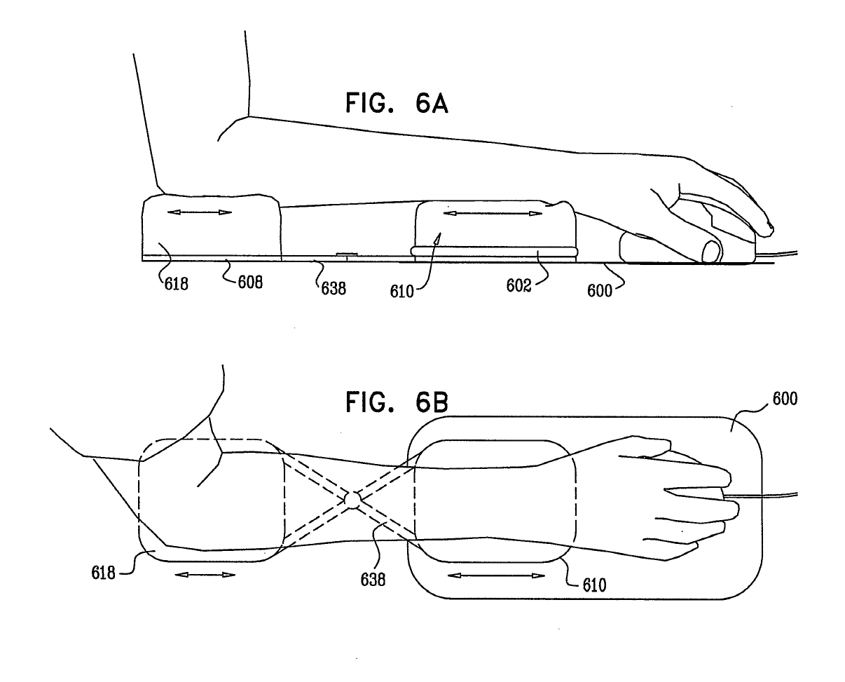

FIG. 6A is a perspective view of the embodiment depicted in FIG. 5 showing said preferred embodiment with forearm situated above it, from a lateral view. Note: arrows depicting different freedom of movement between the two interconnected cushions. The proximal base (608) and the cushion (618) situated above it, allow for an amount of sliding which is less than the sliding motion allowed by the distal base (600) and the distal cushion (602) and the motorized support (610). Thus the relative movement of each interconnected component, that is the proximal support and distal support which are interconnected by the slants (638) is not equal and a tensioning force is formed which anatomically relays a tensioning force over the transverse carpal ligament which overlies the carpal tunnel. This motion, in turn, may allow for some tension to be formed between the proximal forearm and the more distal forearm and wrist, a tension which may act upon the carpal tunnel, and specifically stretch and release the transverse carpal ligament adding to its elasticity over time. The difference in motion magnitude may be appreciated by the relative length of the two movement defining arrows, situated next to each component.

FIG. 6B is a perspective view of the embodiment depicted in FIG. 5 showing said preferred embodiment with forearm situated above it, from above (AP view) note arrows depicting different freedom of movement between the two interconnected cushions. The proximal base (not shown) and the cushion (618) situated above it, allow for an amount of sliding which is less than the sliding motion allowed by the distal base (600) and the distal cushion (not shown) and the motorized support (610). Thus the relative movement of each interconnected component, that is the proximal support and distal support which are interconnected by the slants (638) is not equal and a tensioning force is formed which anatomically relays a tensioning force over the transverse carpal ligament which overlies the carpal tunnel. This motion, in turn, may allow for some tension to be formed between the proximal forearm and the more distal forearm and wrist, a tension which may act upon the carpal tunnel, and specifically stretch and release the transverse carpal ligament adding to its elasticity over time. The difference in motion magnitude may be appreciated by the relative length of the two movement defining arrows, situated next to each component.

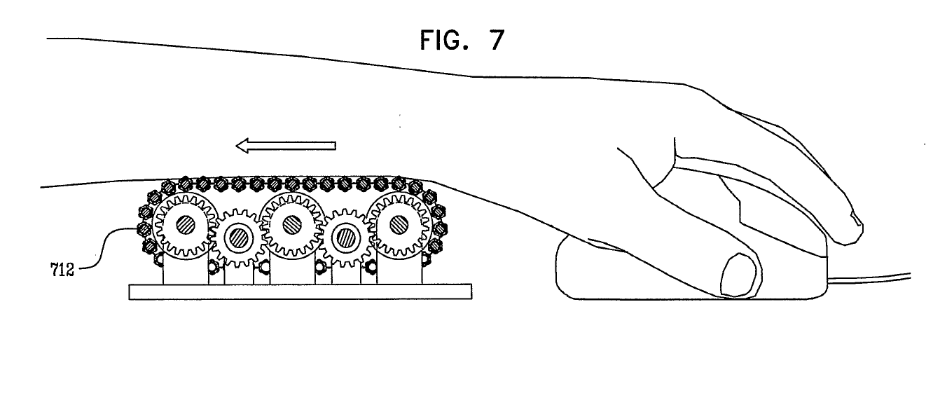

FIG. 7 depicts another possible embodiment of specifically the motor unit component of the invention. This embodiment may be incorporated into the device as shown in FIGS. 1-6 in part, and the concept incorporated in FIGS. 5-6B may be utilized as well. Here, one may appreciate the placement of the distal forearm and wrist areas on the motor unit. The arrow depicts the direction of movement of the rolling cylinder chain (712), which turns again and again. Note that the base (not shown) and cushion (not shown) should be incorporated here as well. The base may act as a surface placemat for use of the computer mouse or may be confined to the limits of the device/support.

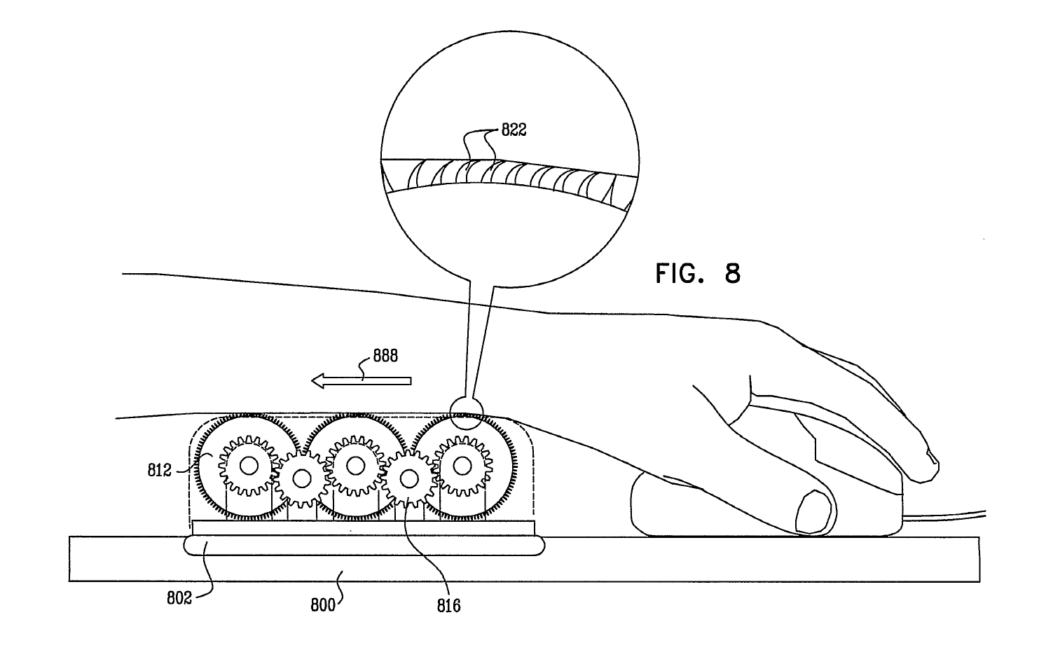

FIG. 8 depicts another possible embodiment of specifically the motor unit component of the invention. This embodiment may be incorporated into the device as shown in FIGS. 1-6 in part, and the concept incorporated in FIGS. 5-6B may be utilized as well. It should be clarified that the motor unit is aimed, once again, at altering the venous blood flow from the distal forearm and hand thus allowing for, at the end of the day, a better supply of nutrients and oxygen and enhanced waist removal as compared to using a support without the invention incorporated in it. Note that the arrow (888) depicts the direction of action. An action that is derived from the moving cylinders—in this embodiment, which continually move and supply pressure at determined increments, rate, and force to the volar aspect of the distal forearm and wrist in a distal to proximal direction. This motion is not coupled with user's movement. The outer casing of the motor unit is depicted by the dotted line. As part of the support, not shown here, a number of semi-solid ridges supporting the local carpal anatomy including the scaphoid tuberosity, triquetral volar ridge, the hook of hamate and thenar musculature may be incorporated.

In FIG. 8, one may appreciate the placement of the distal forearm and wrist areas on the motor unit. The arrow (888) depicts the direction of movement of the rolling cylinders (one of them denoted by the number 812), which turn again and again. Note that the base (800) and cushion (802) should be incorporated here as well. The base may act as a surface placemat for use of the computer mouse or may be confined to the limits of the device/support. In this embodiment, the rolling cylinders (one of them denoted by the number 812), have incorporated at their end (or ends) a cog-wheel and together form a series of cog-wheels allowing for their propelling. The detached cog-wheels (one of them denoted by the number 816) allow for the propagation of all rolling cylinders in effectively the same direction, and thus the desired effect of rolling from distal to proximal (denoted by arrow 888) is gained. These cylinders will roll by attaching the motor itself (not shown) to one or more of the cog-wheels. The current embodiment uses a series of elongated brush-like or alternatively windshield-wiper like hairs or bulges (822) which may in turn give way to pressure exerted by the distal forearm and wrist and which may be of different caliber, texture, shape and form. These markings may very well incorporate anatomical considerations in their placing and form appreciated by those familiar with the art. It must be noted that the rolling cylinders (one of them denoted by the number 812) shown here may be of a much larger number and of a much smaller diameter than that shown here, ending in a series of numerous cylinders with respective cog-wheels interconnecting them, and which may or may-not be covered by bulges or filaments or the like.

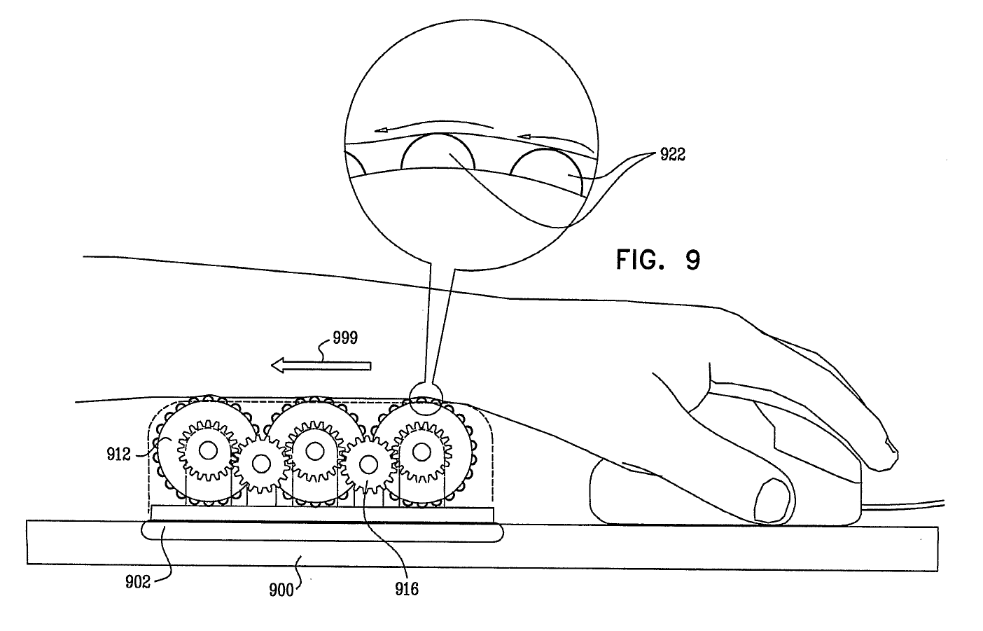

FIG. 9 depicts another possible embodiment of the invention. This embodiment may be incorporated into the device as shown in FIGS. 1-6 in part, and the concept incorporated in FIGS. 5-6B may be utilized as well. It should be clarified that the motor unit is aimed, once again, at altering the venous blood flow from the distal forearm and hand thus allowing for, at the end of the day, a better supply of nutrients and oxygen and enhanced waist removal as compared to using a support without the invention incorporated in it. Note that the arrow (999) depicts the direction of action. An action that is derived from the moving cylinders—in this embodiment, which continually move and supply pressure at determined increments, rate, and force to the volar aspect of the distal forearm and wrist in a distal to proximal direction. This motion is not coupled with user's movement. The outer casing of the motor unit is depicted by the dotted line. As part of the support, not shown here, a number of semi-solid ridges supporting the local carpal anatomy including the scaphoid tuberosity, triquetral volar ridge, the hook of hamate and thenar musculature may be incorporated.

In FIG. 9, one may appreciate the placement of the distal forearm and wrist areas on the motor unit. The arrow (999) depicts the direction of movement of the rolling cylinders (one of them denoted by the number 912), which turn again and again. Note that the base (900) and cushion (902) should be incorporated here as well. The base may act as a surface placemat for use of the computer mouse or may be confined to the limits of the device/support. In this embodiment, the rolling cylinders (one of them denoted by the number 912), have incorporated at their end (or ends) a cog-wheel and together form a series of cog-wheels allowing for their propelling. The detached cog-wheels (one of them denoted by the number 916) allow for the propagation of all rolling cylinders in effectively the same direction, and thus the desired effect of rolling from distal to proximal (denoted by arrow 999) is gained. These cylinders will roll by attaching the motor itself (not shown) to one or more of the cog-wheels. The current embodiment uses a series of rounded bulges (922) which may in turn exert pressure on the distal forearm and wrist and which may be of different size, diameter, texture, shape and form. These markings may very well incorporate anatomical considerations in their placing and form appreciated by those familiar with the art. It must be noted that the rolling cylinders (one of them denoted by the number 912) shown here may be of a much larger number and of a much smaller diameter than that shown here, ending in a series of numerous cylinders with respective cog-wheels interconnecting them, and which may or may-not be covered by bulges or filaments or the like.

FIG. 10A shows a computer user while using the computer keyboard in conjunction with another possible embodiment of the current invention. The apparatus (1000) is a support for the wrist and/or distal forearm which supplies an uncoupled movement to the volar aspect of these areas—thus enhancing venous flow in the relative region and beyond. It is noted that the shape of this device may be different than that conveyed in the figure—as to a possibility of two separate rests or a rest which may be contoured in a different manner so as to employ further ergonomic principles. The support may be utilized in conjunction with a dual or single apparatus (not shown) similar to the embodiment shown in FIGS. 5-6B employing a proximal support with a cushion that is of a smaller freedom of movement or “slack” interval than that of the support at the distal forearm and wrist and thus allowing for a continuous tensioning of the volar transverse carpal ligament—as already explained above in the relevant section. Further, a pattern imprinted on the support itself in a form similar to that of a target (i.e.—shortened distance between each pattern aiming at the preferred parking spot may be used in this embodiment as well. Use of this pattern may very well shorten the “parking” time of the wrist and distal forearm in their correct placing. A series of internal supports aimed at supporting key anatomical points as stated above may further be utilized.

FIG. 10B depicts a sectional view of the embodiment of the current invention shown in FIG. 10A. It should be clarified that the motor unit (depicted only partially) is aimed, once again, at altering the venous blood flow from the distal forearm and hand thus allowing for, at the end of the day, a better supply of nutrients and oxygen and enhanced waist removal as compared to using a support without the invention incorporated in it. Enhanced venous flow in the vicinity of the said device will be appreciated by those familiar with the art to better the condition of those using the current invention. Note that the arrow (1111) depicts the direction of action. An action that is derived from the moving cylinders—in this embodiment, which continually move and supply pressure at determined increments, rate, and force to the volar aspect of the distal forearm and wrist in a distal to proximal direction. This motion is not coupled with user's movement. The outer casing of the motor unit is depicted by the dotted line. As part of the support, not shown here, a number of semi-solid ridges supporting the local carpal anatomy including the scaphoid tuberosity, triquetral volar ridge, the hook of hamate and thenar musculature may be incorporated.

In FIG. 10B, one may appreciate the placement of the distal forearm and wrist areas on the motor unit. The arrow (1111) depicts the direction of movement of the rolling cylinders (one of them denoted by the number 1112), which turn again and again. Note that the base (1001) and cushion (1002) should be incorporated here as well. The base may act as a surface for placing or adjusting placement of the keyboard or may be confined to the limits of the device/support. In this embodiment, the rolling cylinders (one of them denoted by the number 1112), have incorporated at their end (or ends) a cog-wheel and together form a series of cog-wheels allowing for their propelling. The detached cog-wheels (one of them denoted by the number 1116) allow for the propagation of all rolling cylinders in effectively the same direction, and thus the desired effect of rolling from distal to proximal (denoted by arrow 1111) is gained. These cylinders will roll by attaching the motor itself (not shown) to one or more of the cog-wheels or to a propelling means transferring the energy derived from the motor. The current specific embodiment uses a series of elongated brush-like or alternatively windshield-wiper like hairs or bulges (not numbered—depicted subtly) which may in turn give way to pressure exerted by the distal forearm and wrist and which may be of different caliber, texture, shape and form. These markings may very well incorporate anatomical considerations in their placing and form as may be appreciated by those familiar with the art. As well, in a similar embodiment (not shown) rounded bulges (similar to those shown in FIG9 numbered 922) may be utilized, which may in turn exert pressure on the distal forearm and wrist and which may be of different size, diameter, texture, shape and form. These markings may very well incorporate anatomical considerations in their placing and form as well, as may be appreciated by those familiar with the art. It must be noted that the rolling cylinders (one of them denoted by the number 1112) shown here may be of a much larger number and of a much smaller diameter than that shown here, ending in a series of numerous cylinders with respective cog-wheels interconnecting them, and which may or may-not be covered by bulges or filaments or the like.

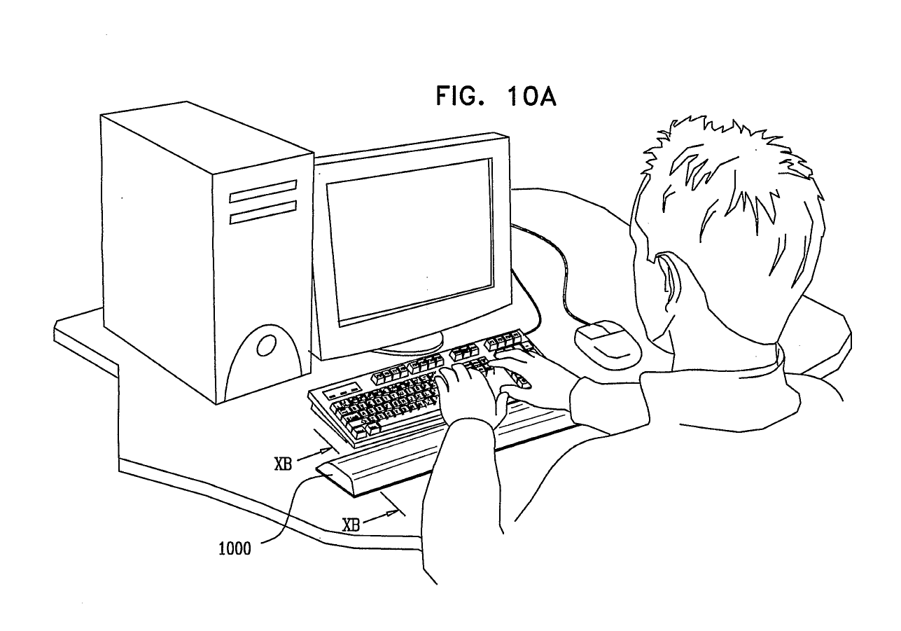

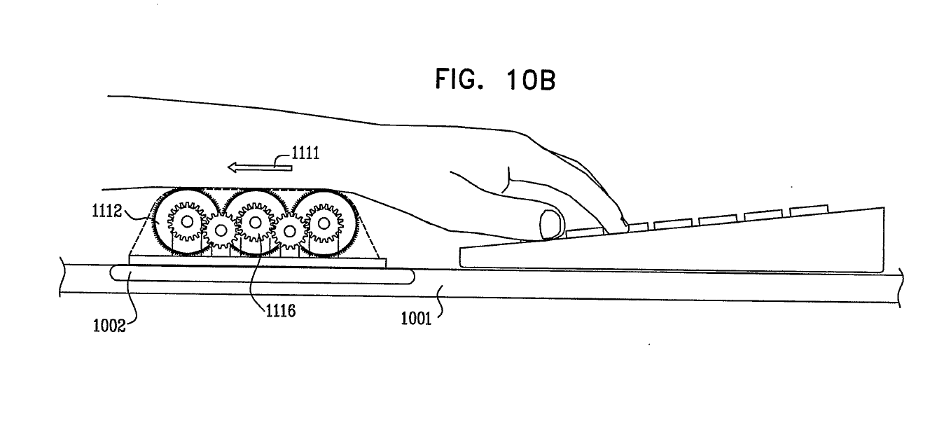

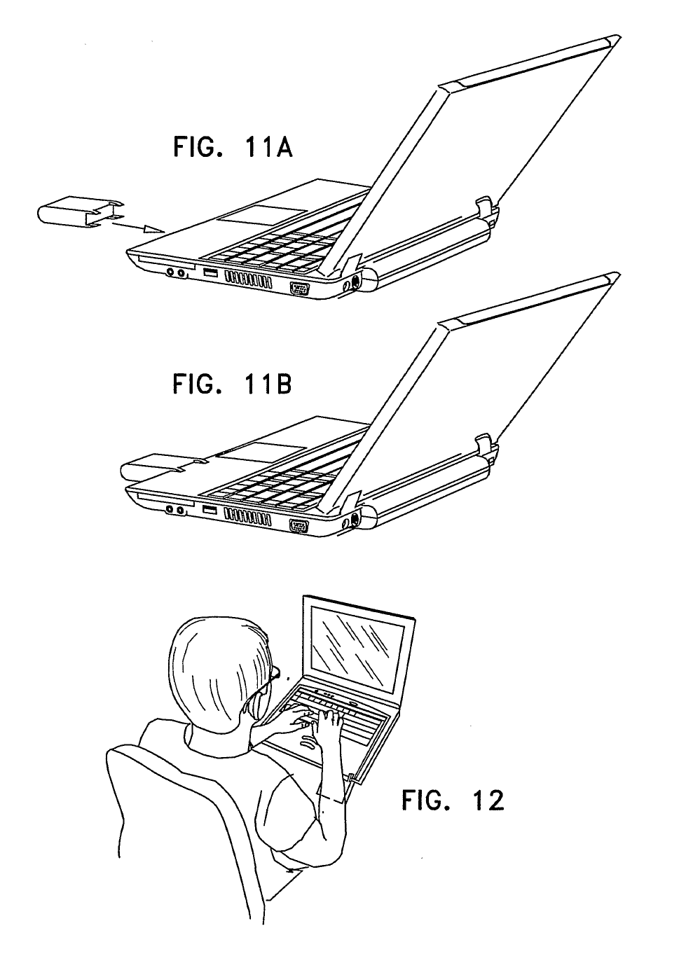

FIG. 11A is a perspective view of a support structured to allow for its attachment or placing adjacent to a portable computer. This figure depicts said support when not attached to portable computer, whilst said support may utilize concepts depicted in any of the above FIGs. In this figure we see a possible attachment of the support which may span part or all of the portable computer edge or even be wider than that edge. As well, the support may be attached to the portable computer by either locking screws, closing clamps or any other form of attachment, as well as possibly other means or no attachment at all—just laying the support adjacent to the laptop computer edge.

FIG. 11B is a perspective view of a support structured to allow for its attachment or placing adjacent to a portable computer. This figure depicts said support when attached to portable computer, whilst said support may utilize concepts depicted in any of the above FIGs. In this figure the support is attached to the laptop computer.

FIG. 12 is a perspective view of a support structured to allow for its attachment or placing adjacent to a portable computer. This figure depicts said support when attached to portable computer, and used by user, whilst said support may utilize concepts depicted in any of the above FIGs. Said support may span the entire portable computer edge or further. Note in this figure placement of laptop computer with respect to user depicted in the drawing.

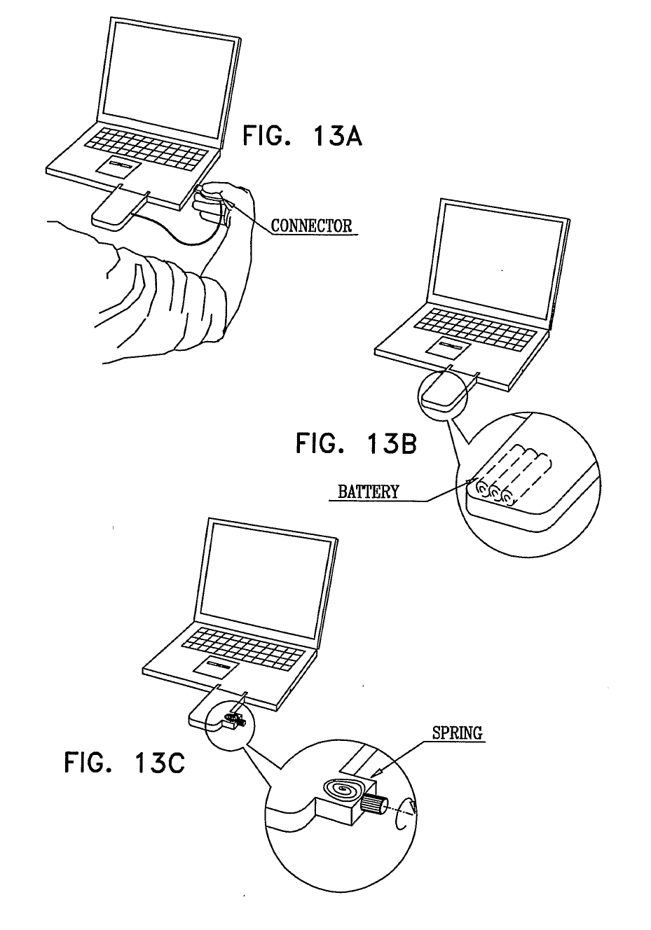

FIG. 13A is a perspective view of a support structured to allow for its attachment or placing adjacent to a portable computer. This figure depicts said support when attached to portable computer, whilst said support may utilize concepts depicted in any of the above FIGs. The support is powered utilizing the USB outlet or other power source tangible for supplying the support with power. The support itself utilizes a motor to deliver the uncoupled force mentioned earlier and this is powered by energy delivered by the cable through the connector to the USB or other power outlet connected to the computer. This power may be allocated from the general electric network as well.

FIG. 13B is a perspective view of a support structured to allow for its attachment or placing adjacent to a portable computer. This figure depicts said support when attached to portable computer, whilst said support may utilize concepts depicted in any of the above FIGs. The support is powered utilizing a battery pack for supplying the support with power. This concept may be utilized when one is compelled to allow for an independent source of energy not impeding the limited power supply of the innate coputer battery. This battery pack may utilize a rechargeable concept using a cable similar to that in FIG. 13A as a power source for recharging.

FIG. 13C is a perspective view of a support structured to allow for its attachment or placing adjacent to a portable computer. This figure depicts said support when attached to portable computer, whilst said support may utilize concepts depicted in any of the above FIGs. The support is powered utilizing a spring mechanism which may be manually “charged” or “cocked up” for supplying the support with power.

In this embodiment manual power is initially utilized to “cockup” the mechanism delivering the uncoupled force utilized for altering venous blood flow—thus both gaining an effect of “work brake” while “cocking up” the device and using it in conjunction with computer use without having to impede on the work span of the laptop due to further encroaching on the energy supply of the battery in order to supply the energy for the uncoupled desired effect on blood flow in the wrist. All concepts depicted in FIGS. 13A-13C may be utilized either on their own or in conjunction with one another.

It should be appreciated that those familiar with the art may easily devise other embodiments supplying an uncoupled movement from distal to proximal at the wrist and distal forearm. This may be performed by use of different enrgy forms, different mechanical setup, altering components in mechanical setups as presented above and herein, and by other means.

While the inventive specially designed supports aimed at supporting the proximal and/or distal forearm and wrist areas while actively transferring a limited and directed pressure to the volar aspect of the distal forearm and wrist, with pressure wave exerted from distal to proximal at a determined magnitude and cycle repetition rate uncoupled with user movement thus enhancing venous sufficiency are described herein in the context of particular embodiments these are not intended to limit the application of the invention disclosed to these limited embodiments. It is clarified that those skilled in the art will appreciate the application of this current invention and its merits to other embodiments in the field.

Moreover, while the inventive specially designed supports aimed at supporting the proximal and/or distal forearm and wrist areas may incorporate the object of the current invention to incorporate a higher degree of sliding and “freedom” at the distal base and less sliding or “freedom” of movement in the proximal base, thus the proximal and distal supports may allow for a “floating” motion due to the fact they are both elevated by cushions. The proximal base and cushion incorporated in the inventive specially designed support, allow for an amount of sliding which is less than the sliding motion allowed by the distal base and distal cushion and motorized support. Thus the relative movement of each interconnected component, that is the proximal support and distal support which are interconnected is not equal and a tensioning force is formed which anatomically relays a tensioning force over the transverse carpal ligament which overlies the carpal tunnel. This motion, in turn, may allow for some tension to be formed between the proximal forearm and the more distal forearm and wrist, a tension which may act upon the carpal tunnel, and specifically stretch and release the transverse carpal ligament adding to its elasticity over time. This principle is new to the art and is incorporated here in the context of particular embodiments which are not intended to limit the application of the invention disclosed to these limited embodiments. It is clarified that those skilled in the art will appreciate the application of this current invention and its merits to other embodiments in the field.

Moreover, while the inventive specially designed supports aimed at supporting the proximal and/or distal forearm and wrist areas may incorporate a further object of the current invention to incorporate a design of the patterns on the embodiments incorporating a “target” like pattern—i.e.—shortened distance between each pattern aiming at the preferred parking spot may be incorporated in these specially designed embodiments. Whilst use of this pattern may very well shorten the “parking” time of the wrist, distal forearm and proximal forearm in their correct place upon the embodiment. This principle, which is new to the art and is incorporated here in the context of particular embodiments which are not intended to limit the application of the invention disclosed to these limited embodiments. It is clarified that those skilled in the art will appreciate the application of this current invention and its merits to other embodiments in the field.

Moreover, while the inventive specially designed supports aimed at supporting the proximal and/or distal forearm and wrist areas may incorporate a further object of the current invention to incorporate a number of semi-solid ridges supporting the local carpal anatomy including the scaphoid tuberosity, triquetral volar ridge, the hook of hamate and thenar musculature in their own right or with the addition of a system allowing for changing their placement by use of a lever or other means to accommodate for different hand sizes may be incorporated in the embodiments specifically described herein. This principle, which is new to the art and is incorporated here in the context of particular embodiments which are not intended to limit the application of the invention disclosed to these limited embodiments. It is clarified that those skilled in the art will appreciate the application of this current invention and its merits to other embodiments in the field.

1. A specifically designed support for a computer user's wrist and forearm which exerts a force generally in a distal to proximal direction at a determined magnitude and cycle repetition rate thus enhancing venous sufficiency and consequently circulation, which is not coupled with user's movement, the support surface comprising:
a base allowing support to be stabilized on the desk next to data entry device; and
a wrist and distal forearm support supplying a pressure directed from distal to proximal at a predetermined magnitude, repetition cycles and area—preferentially aimed at altering fluid movement through the venous system and subsequently the connected bodily tissues, in the volar aspect of the wrist.

2. The support of claim 1 wherein the support further comprises a series of support members at key anatomical locations, which may be shifted as to allow for support of different forearm and wrist sizes.

3. The support of claim 1 wherein the support may be situated on a viscous bag filled with gas or liquid substance, and/or in which the degree of filling may be controlled by the user.

4. The support of claim 1 wherein the support is comprised of one or more rolling pins, at least one connected to a motor unit, and the pins further rolling in same direction by utilizing an interconnection of cog-wheels or other mechanical means—the pins movement aimed at compressing preferentially the venous system of the volar wrist and distal forearm, while exerted pressure and movement is in the distal to proximal direction.

5. The support of claim 1 wherein the support is comprised of one or more rolling pins, at least one connected to a motor unit, and the pins further pushing a belt which is covered by a series of bulges situated at positions aimed at compressing preferentially the venous system of the volar wrist and distal forearm.

6. The support of claim 1 wherein the support is comprised of a set of projections connected to a plate which repeatedly and not necessarily evenly is prompted to compress the volar aspect of the wrist. Essentially, the distal part of the plate will come in contact with the tissues before the proximal part and the plate will then be retracted in order to repeat the process over and over. The plate may be covered by a series of bulges or patterns situated at positions aimed at compressing preferentially the venous system of the volar wrist and distal forearm.

7. The support of claim 1 wherein the support is comprised of one or more rolling pins, at least one connected to a motor unit, and the pins further pushing a belt which is comprised of a series of cylinders rolling in a distal to proximal direction.

8. The support of claim 1 wherein the support is comprised of two or more rolling cylinders, at least one connected to a motor unit, or connected to a motor unit by a cog-wheel. The cylinders may be covered by a series of bulges or patterns or protrusions situated at positions aimed at compressing preferentially the venous system of the volar wrist and distal forearm.

9. The support of claim 1 wherein the support is comprised of two or more rolling cylinders, at least one connected to a motor unit, or connected to a motor unit by a cog-wheel. The cylinders may be covered by a series of hair-like protrusions or windshield wiper like protrusions aimed at compressing preferentially the venous system of the volar wrist and distal forearm.

10. The support of claim 1 wherein the support is comprised of two or more rolling cylinders, at least one connected to a motor unit, or connected to a motor unit by a cog-wheel, aimed at compressing preferentially the venous system of the volar wrist and distal forearm.

11. The support of claim 1 wherein the support is comprised of two or more rolling cylinders, at least one connected to a motor unit, or connected to a motor unit by a cog-wheel. The cylinders may be interconnected by alternating a cylinder connected to a cog-wheel in either or both of its ends and then a cog-wheel with no cylinder connected to it. Thus allowing all cylinders to rotate at same direction, magnitude and speed.

12. The support of claim 1 wherein the support is comprised of a series of bulging and protruding elements which stem from a common base their combined movement conveying a “pressure wave” from distal to proximal.

13. The support of claim 1 wherein the support is comprised of a series of inflatable chambers conveying a “pressure wave” from distal to proximal aimed at compressing the tissues of the volar wrist and forearm.

14. The support of claim 1 wherein the support is comprised of a series of rolling chains, at least one connected to a motor unit, directly or via a energy passing mechanism aimed at compressing preferentially the venous system of the volar wrist and distal forearm.

15. The support of claim 1 wherein the support has a presence detection mechanism aimed at asserting when the wrist or forearm may engage the device—and thus signaling the motor to work and the system to enhance venous flow. The presence detection performed via mechanical pressure assertion, temperature change, light emission blockage or changes in light absorption, or other technical means as known to the art.

16. The support of claim 1 wherein the support is covered by an outer casing employing a “target” pattern, which in essence is a series of lines between which the distance is lessened as they are situated closer to the target or “parking” area of the wrist or forearm.

17-19. (canceled)

20. The support of claim 1 wherein the support is comprised of two or more rolling cylinders, at least one connected to a motor unit, or connected to a motor unit by a cog-wheel. The cylinders may be covered by a series of bulges or patterns situated at positions aimed at compressing preferentially the venous system of the volar wrist and distal forearm.

21. The support of claim 1 wherein the support is comprised of a module equipped with probe or probes which may convey ultrasound or other wave type energy to the volar aspect of the distal forearm and wrist thus aimed at preferentially affecting and causing movement of fluid within the tissues of the volar wrist and distal forearm.

22. The support of claim 1 wherein the support is connected to the computer hardware and/or software which either in conjunction, or on their own, communicate with or activate said support. This software possibly having one of the following: a time counting element, a guide to drills to be performed by the hands at certain intervals, a guide to possible ailments and worrisome symptoms with relation to computer use, a ergonomic guide and info pack, a connection to an internet site or sites, a unit allowing for control of said support functions including speed of rotation, work of unit, inflation of support base, work intervals, activation of unit upon movement of mouse, or possibly following delay.

23-26. (canceled)

27. A support for the forearm and wrist comprised of at least two points of contact to the anatomical bodily structures. It is a general consideration that said support optimize position of wrist to allow for a large volume of carpal tunnel—i.e. the wrist being generally in line with forearm. The support comprising:
A proximal part which has a base and mounted upon it a cushion or rest allowing for a range of movement in the horizontal plane; and
A more distal area of contact which allows for a larger range of movement in the horizontal plane.

28-50. (canceled)
